(19) United States
(12) Patent Application Publication
(10) Pub. No.: US 2026/0321981 A1
(43) Pub. Date: Oct. 15, 2026

(54) An Antenna

(71) Applicant: Leonardo UK Ltd, London (GB)

(72) Inventor: Brian SCANNELL, London (GB)

(73) Assignee: Leonardo UK Ltd, London (GB)

(21) Appl. No.: 19/483,139

(22) PCT Filed: May 10, 2024
(86) PCT No.: PCT/EP2024/062943

§ 371 Date: Nov. 10, 2025

(30) Foreign Application Priority Data
May 10, 2023 (GB) 2306868.7

(51) Int. Cl. H01Q 9/27; H01Q 1/36

(52) U.S. Cl. CPC H01Q 9/27; H01Q 1/36

(57) ABSTRACT

A spiral antenna includes multiple conductive spiral arms formed on a multi-faceted substrate. The multiple arms trace a path that transitions from a circular spiral, e.g. a logarithmic or Archimedean spiral, to an elliptical spiral.

The lower limit of an antenna's physical size is governed by the lowest desired frequency of operation. For broadband planar antenna, such as spiral and log-periodic antenna, this corresponds to a minimum physical diameter of the antenna that can accommodate conductive arms of sufficient length to radiate into free space efficiently at the lowest frequency of operation.

In certain applications, the space available on the platform carrying the antenna is at a premium. This can mean the planar space available on the platform is smaller than can fit the minimum diameter needed for a planar spiral antenna with the desired low frequency performance.

The invention was conceived to address this problem.

According to a first aspect of the invention there is provided a radio frequency (RF) antenna comprising multiple conductive arms carried on a surface provided by a dielectric support; wherein the surface comprises a central portion connected through an interconnecting portion to a peripheral portion, and wherein at least one of the multiple conductive arms trace a radiating path across all of the central portion, interconnecting portion and peripheral portion; wherein the interconnecting portion has a curvature greater than the central portion and peripheral portion.

With this folded geometry additional surface area is provided out of the plane of the central portion allowing for a larger antenna geometry where space in the plane of the central portion is restricted.

The surface may comprise a second peripheral portion connected through a second interconnecting portion to the central portion; wherein at least one of the multiple conductive arms traces a path across the central portion, the second interconnecting portion and the second peripheral portion; and wherein the second interconnecting portion has a curvature greater than the central portion and the second peripheral portion. The provision of the second peripheral portion further increases the surface area available for the conductive arms. Typically the second peripheral portion lies on an oppositely facing side of central portion to the first peripheral portion.

The central portion may be substantially planar. The first and/or second peripheral portion may be substantially planar. The first and/or second interconnecting portions may have a radius of curvature that is less than a quarter of the smallest planar dimension of the central portion though it is favourably much smaller to provide a narrow interconnecting edge between the central and peripheral portions. The angle subtended by the arched interconnection portion may be between 80 degrees and 100 degrees inclusive, though favourably around 90 degrees. Thus the plane of the planar central portion may be substantially orthogonal to those planes in which the planar first and/or second peripheral portions lie. The planes in which the planar first and second peripheral portions lie may be parallel.

For certain applications, where constrained by the geometry of the platform carrying the antenna, a maximum surface area size of the central portion may be achieved through a central portion geometry in which the central portion has two longer (e.g. parallel) sides and two shorter sides. The first peripheral portion may be connected about a first of these longer sides. The second peripheral portion may be connected to the central portion about the other parallel side through the second interconnecting portion.

The first and second peripheral portions and interconnecting portion may be narrower than the width of the respective longer side of the central portion to which they are conjoined such that the central portion defines lateral portions lying laterally beyond the first and second peripheral portions. One or each conductive arm may extend over each lateral portion.

The RF antenna may be a broadband antenna with a fractional bandwidth ratio of at least 3:1.

The multiple conductive arms may be multiple conductive spiral arms. Nevertheless, the invention may also have applicability to other planar broadband antenna designs such as sinuous and log-periodic.

The multiple conductive arms may trace a substantially circular spiral path across the surface, such as an Archimedean or logarithmic spiral path, and transition into an elliptical path (which produces an elliptical beam shape (which is a non-rotationally symmetrical beam shape)) with increasing radial distance from the centre of the spiral. This path geometry provides the ability to provide a rotationally symmetric beam shape at higher frequencies, whilst the elliptical spiral path allows for spiral arms that are as long as possible with the dielectric sheet geometry described above, to improve low frequency performance.

Described another way, inner revolutions of the multiple conductive arms may trace a substantially circular spiral across the surface and outer revolutions of the spiral may trace an elliptical spiral path across the surface.

To increase the track spacing at the edge of the spiral, each conductive arm may have an arm track width that reduces with increasing radial distance from the centre of the spiral. The spacing between adjacent conductive arms may increase with increasing radial distance from the centre of the spiral. The increasing track spacing may be achieved at least in part through reducing the track width with increasing radial distance from the centre of the spiral. Increased track spacing at the periphery can reduce the RF reflection of the track open circuit at the periphery, improving its radiation efficiency.

In one embodiment, the antenna may further comprise a spacer and a reflector, the spacer arranged between the RF reflector and the dielectric support to maintain a predetermined physical spacing between the dielectric support and the RF reflector.

The dielectric support may be mounted over a reflector such that: the central portion lies against a first side of the spacer, the first peripheral portion lies against a second side of the spacer, and the second peripheral portion, if present, lies against a third side of the spacer.

The invention is now described by way of example with reference to the following figures, in which:

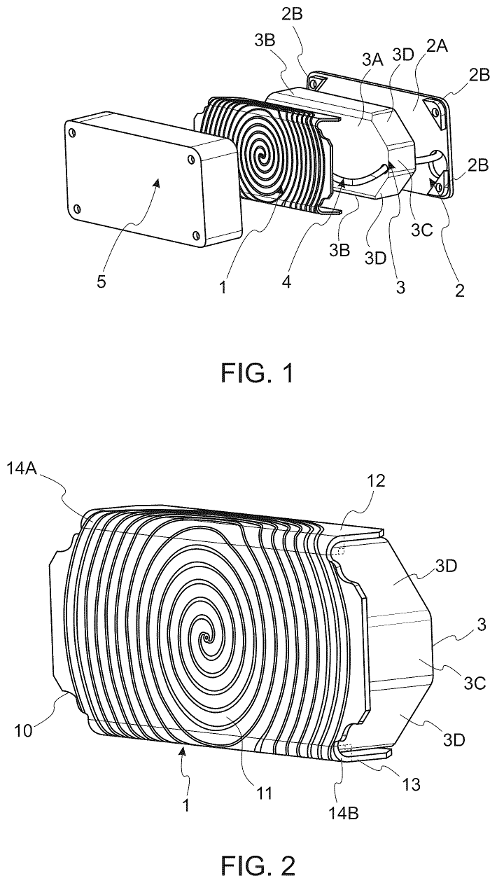

FIG. 1 is an exploded perspective view of a broadband antenna;

FIG. 2 illustrates the folded dielectric sheet carrying spiral antenna arms mounted on the spacer; and

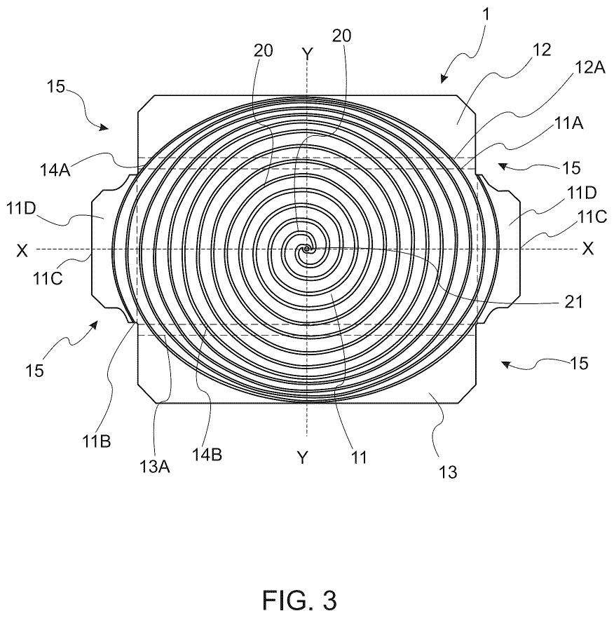

FIG. 3 illustrates the dielectric sheet prior to folding.

With reference to FIG. 1 there is shown an antenna assembly comprising a broad band spiral antenna 1, a RF reflector 2, a spacer 3, an antenna feed 4, and a radome 5.

When assembled, the antenna 1 is mounted over the spacer 3, as illustrated in FIG. 2, and this subassembly retained within a closed cavity formed when the radome 5 is mounted against a first side 2A of the reflector 2. The radome 5 is secured against the first side of the reflector 2 using fasteners and/or lugs, not shown, that extend through apertures 2B provided in the corners of the reflector 2. The fractional bandwidth ratio of the antenna in operation is at least 3:1 though it may be significantly larger than this.

The spacer provides a desired spacing between the antenna 1 and RF reflector 2 to maximise transmitted output power and/or modify the radiation pattern. The spacer 3 comprises an end face 3A, two parallel wide side faces 3B (upper and lower), and two parallel narrow side faces 3C each meeting the end face at an (optionally chamfered) edge and extending perpendicular to the end face 3A. Extending between adjacent wide and narrow side faces 3B 3C are chamfered side faces 3D such that the spacer 3 has an octagonal prism geometry (though it will be appreciated that the number of side faces may differ). The chamfers provide a gap at each corner of the spacer 3 through which the fasters and/or lugs can extend past the spacer to retain the radome 5 to the reflector 2.

The antenna 1 comprises a dielectric supporting sheet 10 having a folded configuration to cover the end face 3A and wide side faces 3B of the spacer 3. This provides a greater surface area compared with that provided through covering the end face 3A alone, to allow for a longer spiral antenna.

As seen most clearly in FIGS. 2 and 3, the folded dielectric supporting sheet 10 defines a central panel 11 and two peripheral panels 12, 13. The central panel 11 has parallel first and second longer sides 11A 11B, and parallel shorter sides 11C. A first side 12A of the first peripheral panel 12 is joined to the central panel 11 about the first longer side 11A through a first elongate fold portion 14A, and the second peripheral panel 13 is joined to the central panel 11 about the second longer side 11B through a second fold elongate portion 14B.

The peripheral panels 12 13 are shorter than the first and second longer sides 11A 11B such that the central portion 11 defines lateral portions 11D lying laterally beyond the ends of the elongate fold portions 14A 14B. This arrangement provides open regions 15 at each corner through which the fasters and/or lugs can extend past the antenna 1.

As most clearly seen in FIG. 2, within the fold portions 14A 14B the dielectric sheet 10 is curved such that when viewed in cross section, the angle subtended by the arc of the curve is approximately 90 degrees. With this arrangement, the planes of the central panel 11 and peripheral panels are perpendicular so that when the antenna 1 is mounted over the support 3, the central panel 11 lies parallel to cover the end face 3A, and the peripheral panels 12 13 lie parallel with and cover the respective parallel wider side faces 3B.

Carried on the dielectric supporting sheet material 10 are metallic tracks that define multiple, in this example two, conductive arms 20. The conductive arms 20 may be formed on the dielectric 10 through any suitable process, e.g. printing or photographic processes comprising deposition and etching, etc.

Each arm 20 traces an outward continuously spiralling path from a centre region 21. The outer turns of each arm 20 trace concentric arcs across the peripheral portions 12 13 crossing to and from the peripheral portions 12 13 over the fold portions 14A 14B.

From the centre region 21, the arms trace Archimedean spirals, which are substantially circular. This provides the preferred rotationally symmetric beam shape at the higher frequencies in the band of operation.

To account for the geometry of the dielectric sheet 10 whilst providing a spiral that is as long as possible to improve low frequency performance, the geometry of the outer turns of the arms 20 transition into elliptical spirals. Any non-rotationally symmetric beam shape caused by the elliptical spiral are mitigated by the longer wavelengths radiated in this region.

The spacing between adjacent turns remains substantially the same about the major axis X-X of the central panel 11 but closes with each outward turn in the orthogonal minor axis Y-Y following the start of the transition. The conductive track width within the elliptical spiral section also decreases gradually along the spiral path to match the narrowing track spacing in the minor axis Y.

The antenna feed 4 extends through an aperture within the RF reflector 2 and spacer 3 to electrically connect to the arms 20 at the centre of the spiral 21.

In one example method of manufacture, the dielectric supporting sheet comprises a flat sheet of RT/Duroid® laminate (or the like) on which the metallic tracks 20 are formed. The sheet is then shaped using heat pressure forming to provide the fold portions 14A 14B.

In possible variants to the embodiment described, the spirals may be logarithmic rather than Archimedean. The conductive arms 20 may trace a sinuous spiral path

1. A radio frequency (RF) antenna comprising:
multiple conductive spiral arms carried on a surface provided by a dielectric support, wherein the surface includes a central portion connected through an interconnecting portion to a first peripheral portion;
wherein at least one of the multiple conductive spiral arms traces a radiating path across the central portion, interconnecting portion and peripheral portion;
wherein the interconnecting portion has a curvature greater than the central portion and peripheral portion; and
wherein the multiple conductive spiral arms trace a path across the surface that transitions from a circular spiral path to an elliptical spiral path.

2. A RF antenna according to claim 1 wherein the surface comprises:
a second peripheral portion connected through a second interconnecting portion to the central portion;
wherein at least one of the multiple conductive arms traces a path across the central portion, the second interconnecting portion and the second peripheral portion; and
wherein the second interconnecting portion has a curvature greater than the central portion and second peripheral portion.

3. A RF antenna according to claim 2, wherein the central portion is substantially planar.

4. A RF antenna according to claim 3, wherein the first and/or second interconnecting portions have a radius of curvature less than a quarter of the smallest planar dimension of the central portion.

5. A RF antenna according to claim 4, wherein the first and/or second peripheral portions are substantially planar.

6. A RF antenna according to any previous claim 5, wherein each conductive spiral arm has an arm track width, and wherein the arm track width reduces with increasing radial distance from a center of the conductive spiral arms.

7. A RF antenna according to claim 6, wherein a spacing between adjacent conductive spiral arms increases with increasing radial distance from the center of the conductive spiral arms.

8. A RF antenna according to claim 7, wherein the arm track width and spacing in a central portion provide a self-complementary spiral geometry.

9. A RF antenna according to claim 8, wherein the first and second peripheral portions are conjoined to oppositely facing sides of the central portion.

10. A RF antenna according to claim 9 wherein the first and second peripheral portions and interconnecting portion are narrower than a width of a respective side of the central portion to which they are conjoined such that the central portion defines lateral portions lying laterally beyond the first and second peripheral portions.

11. A RF antenna according to claim 8, wherein the first and second peripheral portions meet at an edge, and each of the multiple conductive spiral arms traces a path that extends across the first and second peripheral portions across the edge.

12. An RF antenna according to claim 1, wherein the RF antenna is a broadband antenna with at least 3:1 bandwidth.

13. An RF antenna according to claim 1 in an antenna assembly comprising:
the RF antenna;
an RF reflector; and
a spacer arranged between the reflector and antenna, wherein the spacer includes an end face and multiple side faces, and the antenna is arranged such that the central portion sits flat against the end face and the first peripheral portion sits flat against one of the side faces.

14. An antenna assembly according to claim 13, comprising:
a radome, wherein the radome is mounted to the RF reflector to provide a cavity in which the RF antenna and spacer sit.

15. A method of manufacturing a spiral RF antenna, the method comprising: forming conductive tracks defining one or more spiral antenna elements on a dielectric sheet; and
then shaping the dielectric sheet to define one or more bends using a heat forming process.

16. A radio frequency (RF) antenna comprising:
multiple conductive arms carried on a surface provided by a dielectric support, wherein the surface includes a central portion connected through an interconnecting portion to a first peripheral portion;
wherein at least one of the multiple conductive spiral arms traces a radiating path across the central portion, interconnecting portion and peripheral portion; and
wherein the interconnecting portion has a curvature greater than the central portion and peripheral portion.

17. A RF antenna according to claim 2, wherein the first and/or second interconnecting portions have a radius of curvature less than a quarter of the smallest planar dimension of the central portion.

18. A RF antenna according to any previous claim 1, wherein each conductive spiral arm has an arm track width, and wherein the arm track width reduces with increasing radial distance from a center of the conductive spiral arms.

19. A RF antenna according to claim 1, wherein a spacing between adjacent conductive spiral arms increase increases with increasing radial distance from the center of the conductive spiral arms.

20. An RF antenna according to claim 13, wherein the RF antenna is a broadband antenna with at least 3:1 bandwidth.
